(19) United States
(12) Patent Application Publication
(10) Pub. No.: US 2001/0053977 A1
(43) Pub. Date: Dec. 20, 2001

(54) System and method for responding to email and self help requests

(75) Inventor: Frederick Anthony Schaefer, Colorado Springs, CO (US)

Correspondence Address: Law Offices of Dale B. Halling, Suite 311, 24 South Weber St., Colorado Springs, CO, 80903, US

(73) Assignee: Realperson, Inc.

(21) Appl. No.: 09/866,079

(22) Filed: May 25, 2001

Related U.S. Application Data
(60) Provisional application No. 60/212,287, filed on Jun. 19, 2000.

(51) Int. Cl. G10L 21/00

(52) U.S. Cl. 704/270.1

(57) ABSTRACT

A customer service center (10) includes a server (12) connected to a computer network (18). The server (12) contains a speech recognition system (14). An operator station (16) is capable of connecting to the server (12). A microphone (19) is connected to the operator station (16). A codec (20) is connected to the microphone (19) and the operator station (16).

### FIELD OF THE INVENTION

The present invention relates generally to the field of electronic customer service centers.

### BACKGROUND OF THE INVENTION

The internet has caused an explosion in the number of business to consumer and business to business web sites. These sites provide a number of advantages over traditional sales channels such as: salesmen, telephone orders and mail order. These sites generate a large number of email requests that must be answered. However, one significant limitation has been that answering these questions is a time consuming and often labor intensive process for customer service representatives.

Some web sites have automated the process of responding to emails by populating a database with frequently asked questions and canned text responses. When incoming emails ask a question found in the database, an automatic email response is sent. When the incoming emails ask a question not found in the database, the email is presented to a customer service representative to compose and send a text based response.

Thus there is a need for a method of automatically populating a database of frequently asked questions and responses without the need for manually entering the data. In addition, when the question is not found in the database, there is a need for customer service personnel to efficiently answer the question without typing a response.

### BRIEF DESCRIPTION OF THE DRAWINGS

FIG. 1 is a block diagram of a customer service center system in accordance with one embodiment of the invention;

FIG. 2 is a block diagram of a customer service center system in accordance with one embodiment of the invention;

FIG. 3 is a flow chart of the steps used in a method of operating a customer service center in accordance with one embodiment of the invention;

FIG. 4 is a flow chart of the steps used in a method of operating a customer service center in accordance with one embodiment of the invention;

FIG. 5 is a flow chart of the steps used in a method of operating a customer service center in accordance with one embodiment of the invention;

FIG. 6 is a flow chart of the steps used in a method of operating a customer service center in accordance with one embodiment of the invention; and

FIG. 7 is a block diagram of a customer service center system in accordance with one embodiment of the invention.

### DETAILED DESCRIPTION OF THE DRAWINGS

A customer service center includes a server connected to a computer network. The server contains a speech recognition system. An operator station is capable of connecting to the server. A microphone is connected to the operator station. A codec is connected to the microphone and the operator station. The system allows the customer service representative to voice a response to a customer's question. The speech recognition system converts the voiced response to a text response. The text response can be sent over the computer network. In addition, the voice response can be sent to the customer over the computer network. The voice response is encoded into a format that does not require the customer to have a plug-in to hear the voiced response. This system allows the operator to answer questions by voicing the answer. This increases the number of customers the customer service representative can help. The system also does not require the customer to log-off of the web site to get their question answered.

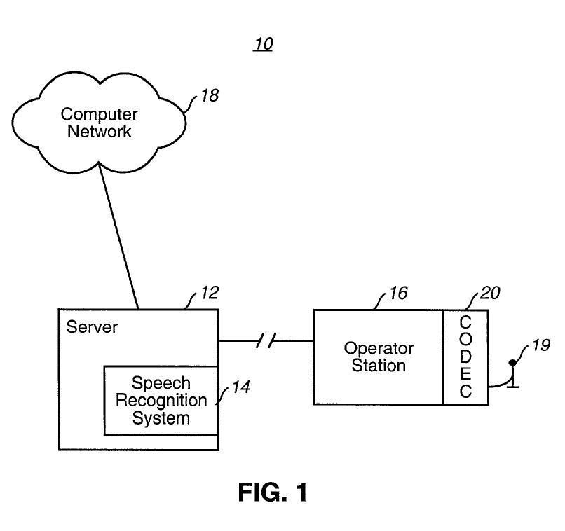

FIG. 1 is a block diagram of a customer service center system 10 in accordance with one embodiment of the invention. The customer service center system 10 has a server 12. The server 12 has a speech recognition system 14. An operator station 16 is capable of connecting to the server 12. The operator station 16 in one embodiment is always connected to the server 12. In another embodiment, the operator station 16 connects to the server 12 through the computer network 18. In yet another embodiment, the operator station 16 only connects to the server 12 when a customer query has been received by the server. This can significantly reduce telephone costs in countries where the telephone company charges for connections by the minute. A microphone 19 is connected to a codec 20 which is connected to the operator station 16.

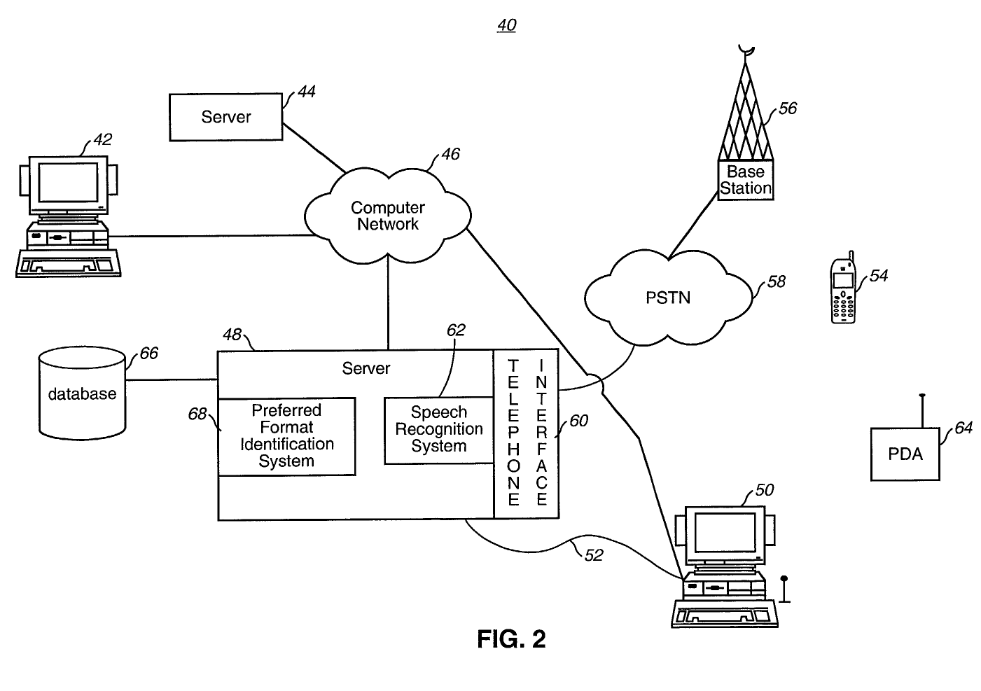

FIG. 2 is a block diagram of a customer service center system 40 in accordance with one embodiment of the invention. A customer computer 42 is connected with a retail web site 44 through a computer network (e.g., the Internet) 46. When a user clicks on an icon on the web page of the retail web site 44, they are connected with a server 48. The server 48 sends a standard introductory response to the customer. The customer can then type in a question. The question is forwarded to an operator station. In one embodiment, the operator station is a computer 50. The computer 50 can be directly 52 connected to the server 48 or the computer can be connected to the server 48 through a computer network 46. When the operator station is a computer, the computer may contain speech recognition software.

In another embodiment, the operator station is a cellular telephone 54. The cellular telephone 54 connects to the server through a base station 56. The base station 56 is connected to the public switched telephone network (PSTN) 58. The PSTN 58 is connected to the server 48 through a telephone interface 60. In this case the speech recognition system 62 in the server 48 is used. In another embodiment, the operator station is a personal digital assistant (PDA) 64. The operator may choose a “standard” or prerecorded response to a question. This is a significant time saving feature. When an operator selects a standard response, the response is accessed in a database 66 connected to the server 48. The database 66 may also keep copies of all responses by the operators.

The server 48, in one embodiment, includes a preferred format identification system 68. The preferred format identification system 68 determines the type of audio player the user has installed on his computer 48. Certain audio players come with particular operating systems. As a result most computers can play WAV files. The system 68 may examine header information to determine the browser type and operating system used by the requesters computer. In addition, the system 68 may send a query to the computer to determine the audio player type. The present embodiment of the system 40 uses a GSM (Global System for Mobile communications) or ADPCM format when possible. Note that by determining the type of audio player on the user's computer 42, the system does not need software plug-ins to send audio to the user's computer 42.

In one embodiment, the user emails a question to the customer service center server 48. The text response created as above and the associated audio file are encapsulated into an email and sent to the user's computer 42.

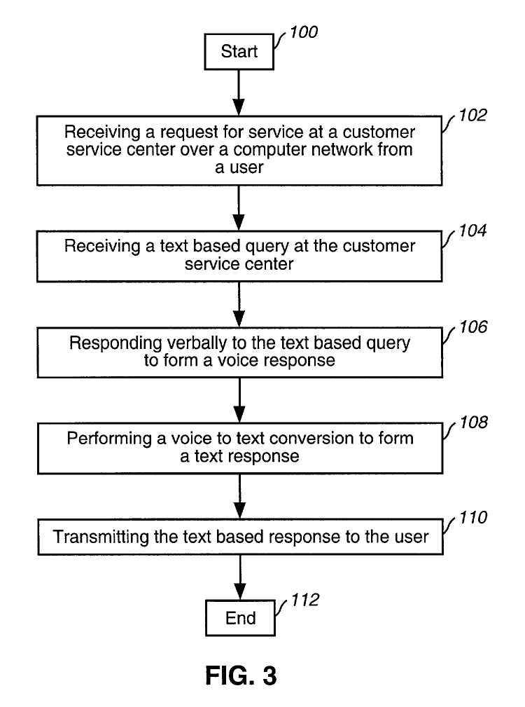

FIG. 3 is a flow chart of the steps used in a method of operating a customer service center in accordance with one embodiment of the invention. The process starts, step 100, by receiving a request for service at a customer service center over a computer network from a user at step 102. A text based query is received at the customer service center at step 104. A verbal response to the text based query is formed at step 106. A voice to text conversion is performed to form a text response at step 108. At step 110, the text based response is transmitted to the user which ends the process at step 112. In one embodiment, a voice based response is transmitted to the user. In one embodiment, a message is sent asking the user if the speakers are on at his computer. When the answer is yes the voice base response is sent to the user.

In one embodiment, an introductory response is sent to user as soon as the server receives the request. The introductory response may explain how the service works and request the user type a question.

The user initiates the service by clicking on a customer service icon on a web page. The requesting computer is then connected to the server at the customer service center. The server then selects one of the plurality of customer service stations to receive the user's questions.

In one embodiment, the server determines a type of browser on the requesting computer. The server may also determine an operating system of the requesting computer. The server or computer operator station converts the voice response from an operator into a format compatible with the browser of the requesting computer. In one embodiment, the server or operator station converts the voice response into a GSM format. Alternatively, the server or operator station could convert the voice response into an ADPCM format. In one embodiment, the operator is presented with the text response and can edit the response before transmission to the user.

In one embodiment, the operator station is a cellular telephone. In another embodiment, the operator station is a personal digital assistant. In one embodiment, the operator station is not always connected to the server. In this case a signal is sent to the operator station. The operator station then connects to the server at the customer service station. When the connection involves a telephone line (voice channel) in a country that charges by the minute for local calls, this feature can significantly reduce the operating cost of the customer service center.

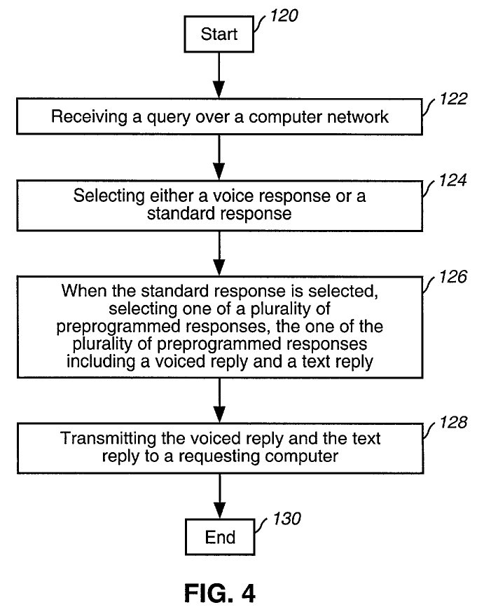

FIG. 4 is a flow chart of the steps used in a method of operating a customer service center in accordance with one embodiment of the invention. The process starts, step 120, by receiving a query over a computer network at step 122. Either a voice response or a standard response is selected by the operator at step 124. When the standard response is selected, one of a plurality of preprogrammed response is selected at step 126. The plurality of preprogrammed responses include a voiced reply and a text reply. At step 128, the text reply and the voice reply are transmitted to a requesting computer which ends the process at step 130. When a voice response is selected, a voiced statement is formed. The voiced statement is converted into a text statement. The text statement is transmitted to the requesting computer.

In one embodiment it is determined if a speaker of a user computer is on. When the speaker is on, the voiced statement is sent to the user. The voiced statement is converted into a digital format.

In one embodiment, an icon is placed on a web page. When the user clicks on the icon they are connected to the customer service center. The server at the customer service center selects one of a plurality of operator station to receive a question. In one embodiment a signal is transmitted to one of the plurality of operator stations. The one of the plurality of operator stations then connects to the server.

In one embodiment, the customer computer includes a codec and the user transmits an audio query over the computer network. In one embodiment, the operator's voiced statement and the text statement are stored on a database. These statements can be mined to determine frequent problems.

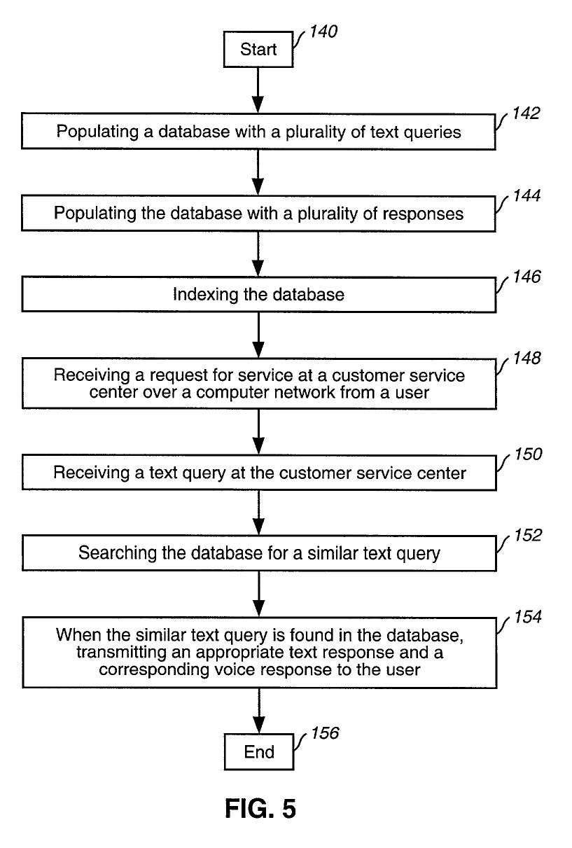

FIG. 5 is a flow chart of the steps used in a method of operating a customer service center in accordance with one embodiment of the invention. The process starts, step 140, by populating a database with a plurality of text queries at step 142. The system populates the database with a plurality of responses at step 144, and indexes the database at step 146. At step 148 the system receives a request for service at a customer service center over a computer network from a user. The system receives a text query at the customer service center at step 150, and searches the database for a similar text query at step 152. When the similar text query is found in the database, the system transmits an appropriate text response and a corresponding voice response to the user at step 154, which ends the process at step 156.

In one embodiment, the appropriate text response is an automated email response. The corresponding voice response is a voice attachment to the automated email response. The automated email response is added to the database. In another embodiment, the appropriate text response is a list of responses with a hyperlink to each response on the list. The hyperlinked list of responses may be within a single email message, or alternatively, the hyperlinked list of responses may be presented at a web page. The system's automatic response may contain only the address to a web page that contains the list of appropriate responses. The automated email response includes a button to allow the user to connect to a customer service operator. In another embodiment, the corresponding voice response is in a format that does not require the user to have a plug-in to hear the corresponding voice response.

In another embodiment, when the similar text query is not found in the database, the system presents the text query to a customer service operator. The customer service operator responds verbally to the similar text query to form a voice response. The customer service operator performs a voice to text conversion to create a text response, and transmits the text response and the voice response to the user, wherein the voice response is in a format that does not require the user to have a plug-in to hear the voice response. The system adds the text query to the database. The system adds the text response to the database. The system adds the voice response to the database.

In another embodiment, the plurality of responses are text responses. In another embodiment, the plurality of responses are both text responses and voice responses. The customer service center is internet-based. In another embodiment, the system identifies key words contained in the plurality of text queries and arranges the database to enable a search for a word. In another embodiment, the system identifies key words contained in the plurality of responses and arranges the database to enable a search for a word.

In another embodiment, the system evaluates which of the plurality of responses are most appropriate with an artificial intelligence system. The system searches the database and receives a plurality of potential responses. The system, or a live operator, then selects a correct response from the plurality of potential responses and sends the correct response to the user. The system converts the appropriate text response into a voice response with a speech synthesizer.

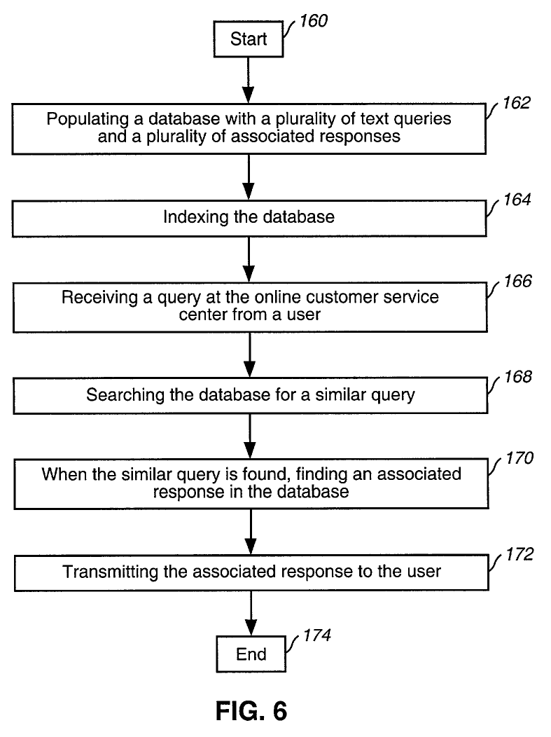

FIG. 6 is a flow chart of the steps used in a method of operating a customer service center in accordance with one embodiment of the invention. The process starts, step 160, by populating a database with a plurality of text queries and a plurality of associated responses at step 162. At step 164, the system indexes the database. The system receives a query at the online customer service center from a user at step 166, and searches the database for a similar query at step 168. When the similar query is found at step 170, the system finds an associated response in the database. The system transmits the associated response to the user at step 172, ending the process at step 174.

In one embodiment, when the system does not find the similar query in the database, it presents the query to a customer service operator. The customer service operator responds verbally to the query to form a voice response. The system performs a voice to text conversion to create a text response, and transmits the text response and the voice response to the user.

In another embodiment, the user's computer plays the voice response without special software. The system performs a text to voice conversion of the associated response using a speech synthesizer to create a synthesized voice response, and transmits the text response and the synthesized voice response to the user.

In another embodiment, the query is an email query from the user. When the similar query is not found, a customer service operator voices a response to the query to create a voice response. The system converts the voice response into a text response, and encapsulates the voice response and the text response into an email response. The system then sends the email response to the customer. In another embodiment, the customer's computer displays the text response of the email response on the customer's computer upon receipt. Alternatively, the customer's computer plays the voice response of the email response on the customer's computer upon receipt.

In another embodiment, the system stores the text response and the voice response on a web page. The system includes a hyperlink to the web page in the situation where the customer's computer is not capable of playing the voice response of the email response. The customer may click on the hyperlink within the encapsulated response to play the voice response.

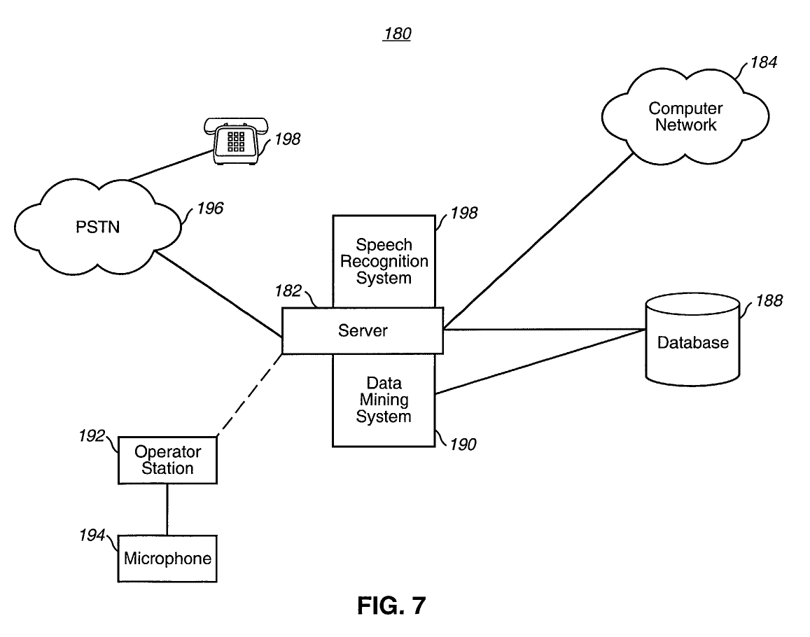

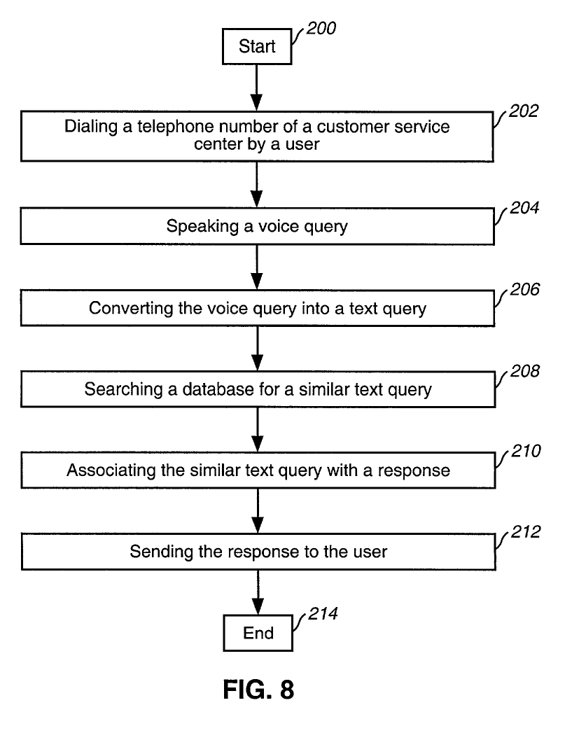

FIG. 7 is a block diagram of a customer service center system 180 in accordance with one embodiment of the invention. A server 182 is connected to a computer network 184 containing a speech recognition system 186. A database 188 is connected to the server 182. A data mining system 190 is connected to the server 182 and the database 188. An operator station 192 is capable of connecting to the server 182, and a microphone 194 is connected to the operator station 192.

In one embodiment, the database 188 is populated with a plurality of text queries and a plurality of text responses. The data mining system 190 is capable of capturing a text query for storage in the database 188. The data mining system 190 is capable of capturing a text response for storage in the database 188.

In another embodiment, the data mining system 190 is capable of comparing a text query to a plurality of text queries stored in the database 188 to find a correct match. The data mining system 190 includes a response evaluation system. In another embodiment the customer service center further comprises a speech synthesizer connected to the server 182. In another embodiment, the server 182 is connected to the PSTN 196. The PSTN 196 permits a user to call a query to the server with a telephone 198.

FIG. 8 is a flow chart of the steps used in a method of operating a customer service center in accordance with one embodiment of the invention. The process starts, step 200, by dialing a telephone number of a customer service center by a user at step 202. At step 204 the user speaks a voice query. The system converts the voice query into a text query at step 206, and searches a database for a similar text query at step 208. At step 210 the system associates the similar text query with a response, and at step 212 the system sends the response to the user which ends the process at step 214.

In one embodiment, the voice query is converted into a text query using a speech recognition system. In another embodiment, the response is an audio response. The audio response is a real voice response stored in the database. In another embodiment, when the system does not find the response, it directs the voice and text query to a customer service operator. The customer service operator speaks a response to the user.

Thus there has been described a system and method of operating a customer service center that can efficiently respond to customer's questions. In addition, the system does not require the user to sign off of their computer to speak to a customer service representative.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of operating an customer service center, comprising the steps of:
(a) populating a database with a plurality of text queries;
(b) populating the database with a plurality of responses;
(c) indexing the database;
(d) receiving a request for service at a customer service center over a computer network from a user;
(e) receiving a text query at the customer service center;
(f) searching the database for a similar text query;
(g) when the similar text query is found in the database, transmitting an appropriate text response and a corresponding voice response to the user.

2. The method of claim 1, wherein the appropriate text response is an automated email response.

3. The method of claim 2, wherein the corresponding voice response is a voice attachment to the automated email response.

4. The method of claim 2, wherein the automated email response is added to the database.

5. The method of claim 1, wherein the appropriate text response is a list of responses with a hyperlink to each response on the list.

6. The method of claim 1, wherein the automated email response includes a button to allow the user to connect to a customer service operator.

7. The method of claim 1, wherein the corresponding voice response is in a format that does not require the user to have a plug-in to hear the corresponding voice response.

8. The method of claim 1, wherein step (f) further includes the steps of:
(f1) when the similar text query is not found in the database, presenting the text query to a customer service operator;
(f2) responding verbally to the similar text query to form a voice response;
(f3) performing a voice to text conversion to create a text response;
(f4) transmitting the text response and the voice response to the user, wherein the voice response is in a format that does not require the user to have a plug-in to hear the voice response.

9. The method of claim 8, wherein step (f1) further includes the step of:
(i) adding the text query to the database.

10. The method of claim 8, wherein step (f3) further includes the step of:
(i) adding the text response to the database.

11. The method of claim 8, wherein step (f3) further includes the step of:
(i) adding the voice response to the database.

12. The method of claim 1, wherein the plurality of responses are text responses.

13. The method of claim 1, wherein the plurality of responses are both text responses and voice responses.

14. The method of claim 1, wherein the customer service center is internet-based.

15. The method of claim 1, wherein step (c) further includes the steps of:
(c1) identifying key words contained in the plurality of text queries; and
(c2) arranging the database to enable a search for a word.

16. The method of claim 1, wherein step (c) further includes the steps of:
(c1) identifying key words contained in the plurality of responses; and
(c2) arranging the database to enable a search for a word.

17. The method of claim 1, wherein step (e) further includes the step of:
(e1) evaluating which of the plurality of responses are most appropriate with an artificial intelligence system.

18. The method of claim 1, wherein step (g) further includes the steps of:
(g1) receiving a plurality of potential responses;
(g2) selecting a correct response from the plurality of potential responses; and
(g3) sending the correct response to the user.

19. The method of claim 1, wherein step (g) further includes to steps of:
(g1) converting the appropriate text response into a voice response with a speech synthesizer.

20. A method of operating an online customer service center, comprising the steps of:
(a) populating a database with a plurality of text queries and a plurality of associated responses;
(b) indexing the database;
(c) receiving a query at the online customer service center from a user;
(e) searching the database for a similar query;
(f) when the similar query is found, finding an associated response in the database;
(g) transmitting the associated response to the user.

21. The method of claim 20, wherein step (e) further comprises the steps of:
(e1) when the similar query is not found in the database, presenting the query to a customer service operator;
(e2) responding verbally to the query to form a voice response;
(e3) performing a voice to text conversion to create a text response; and
(e4) transmitting the text response and the voice response to the user.

22. The method of claim 21, further comprising the step of:
(e5) playing the voice response at a user's computer without a special software program.

23. The method of claim 20, wherein step (f) further comprises the steps of:
(f1) performing a text to voice conversion of the associated response using a speech synthesizer to create a synthesized voice response; and
(f2) transmitting a text response and the synthesized voice response to the user.

24. The method of claim 20, wherein the query is an email query.

25. The method of claim 24, wherein step (e) further includes the steps of:
(e1) when the similar query is not found, voicing a response by a customer service operator to create a voice response;
(e2) converting the voice response into a text response;
(e3) encapsulating the voice response and the text response into an email response; and
(e4) sending the email response to the user.

26. The method of claim 25, further including the step of:
(e5) displaying the text response of the email response on a user's computer upon receipt.

27. The method of claim 25, further including the step of:
(e5) playing the voice response of the email response on a user's computer upon receipt.

28. The method of claim 25, further including the steps of:
(e5) storing the text response and the voice response on a web page;
(e6) when a user's computer is not capable of playing the voice response of the email response, including a hyperlink to the web page; and
(e7) clicking on the hyperlink within the encapsulated response to play the voice response.

29. An customer service center, comprising:
a server connected to a computer network containing a speech recognition system;
a database connected to the server;
a data mining system connected to the server and the database;
an operator station capable of connecting to the server; and
a microphone connected to the operator station.

30. The customer service center of claim 29, wherein the database is populated with a plurality of text queries and a plurality of text responses.

31. The customer service center of claim 29, wherein the data mining system is capable of capturing a text query for storage in the database.

32. The customer service center of claim 29, wherein the data mining system is capable of capturing a text response for storage in the database.

33. The customer service center of claim 29, wherein the data mining system is capable of comparing a text query to a plurality of text queries stored in the database to find a correct match.

34. The customer service center of claim 29, wherein the data mining system includes a response evaluation system.

35. The customer service center of claim 29, further comprising:
a speech synthesizer connected to the server.

36. A method of operating an online customer service center, comprising the steps of:
(a) dialing a telephone number of a customer service center by a user;
(b) speaking a voice query;
(c) converting the voice query into a text query;
(d) searching a database for a similar text query;
(e) associating the similar text query with a response; and
(f) sending the response to the user.

37. The method of claim 36, wherein the voice query is converted into a text query using a speech recognition system.

38. The method of claim 36, wherein the response is an audio response.

39. The method of claim 38, wherein the audio response is a real voice response stored in the database.

40. The method of claim 36, further including the steps:
(g) when the response is not found, directing the text and voice query to a customer service operator; and
(h) speaking a response to the user by the customer service operator.
